(19) United States
(12) Patent Application Publication
(10) Pub. No.: US 2025/0042114 A1
(43) Pub. Date: Feb. 6, 2025

(54) CONTROL METHOD AND CONTROL SYSTEM FOR TIRE FORMING MACHINE, AND READABLE STORAGE MEDIUM

(71) Applicants: MESNAC CO., LTD., Qingdao, SHANDONG PROVINCE (CN); QINGDAO MESNAC MACHINERY& ELECTRIC ENGINEERING CO., LTD., Qingdao, SHANDONG PROVINCE (CN)

(72) Inventors: HUILI YANG, QINGDAO, SHANDONG PROVINCE (CN); GANG XIE, QINGDAO, SHANDONG PROVINCE (CN); YUNFEI LIU, QINGDAO, SHANDONG PROVINCE (CN); DONGYUN HOU, QINGDAO, SHANDONG PROVINCE (CN); YAXIONG CHEN, QINGDAO, SHANDONG PROVINCE (CN)

(21) Appl. No.: 18/723,843

(22) PCT Filed: Dec. 22, 2022
(86) PCT No.: PCT/CN2022/141184

§ 371 Date: Jun. 24, 2024

(30) Foreign Application Priority Data
Dec. 22, 2021 (CN) 202111585277.1

(51) Int. Cl. B29D 30/28; B29D 30/00

(52) U.S. Cl. CPC B29D 30/28; B29D 30/0016; B29D 2030/0022; B29D 2030/0044

(57) ABSTRACT

Disclosed are a control method and control system for a tire forming machine, and a readable storage medium. The control method comprises: in response to a signal for mounting a tire bead, a second mechanical arm body drives a second claw portion to move to a material preparation region, and the second claw portion performs a grasping action on the tire bead and a spacer; the second mechanical arm body drives the second claw portion to place the tire bead on the preset position of the tire bead and place the spacer on the place where the spacer is placed; in response to a green tire rolling signal, a first pressing roller portion rolling a first sidewall of a green tire and an adjacent tread thereof on a forming drum, and meanwhile a second pressing roller portion rolling a second sidewall of the green tire and the adjacent tread thereof; In response to the green tire unloading signal, the first mechanical arm body drives the first claw portion to grip the green tire, and transfers the green tire to the tire unloading position. By means of integrated control, the control method reduces the space occupied by a mechanical device, reduces the complexity of control, and avoids the possibility of interference generated by the mutual actions between the executed mechanical parts.

### CROSS-REFERENCE TO RELATED APPLICATION

The present invention claims priority to and the benefit of Chinese Patent Application No. 202111585277.1, filed to the China National Intellectual Property Administration (CNIPA) on Dec. 22, 2021, which is hereby incorporated by reference in its entirety.

### TECHNICAL FIELD

The present application relates to the technical field of tire building, and in particular, to a control method and control system for a tire building machine, and a readable storage medium.

### BACKGROUND TECHNOLOGY

Generally, tire forming needs to be performed on a tire forming device. In the current tire forming device, there are mainly the following structural designs satisfying the process requirements: a ring-up process (namely, placing a bead on a bead pre-set from a bead car), a rolling process (namely, rolling a crown and a sidewall), and a tire-unloading process (taking a tire blank out of a tire-unloading device and placing same at a designated position), wherein the ring-up process is manually completed, a rolling process is completed by a combined rolling device, and a tire discharging process is completed by a tire discharging device; the upper ring process is completed by a single mechanical arm, the rolling process is completed by a combined rolling device, and the tire unloading process is completed by a tire unloading device; the upper ring process is completed by other automatic upper ring devices, the rolling process is completed by a combined rolling device, and the tire unloading process is completed by a tire unloading device. In the above structural design, an upper ring operation, a rolling operation and a tire discharging operation are respectively completed by using different mechanical apparatuses, so that the mechanical structure of the whole machine is complex, the occupied space is large and the control is complex, and mutual interference is easily generated.

In conclusion, how to solve the problems that the mechanical structure of the whole machine is complex, the occupied space is large, and the control is complex and easy to interfere with each other has become a technical problem to be solved urgently by those skilled in the art.

### SUMMARY OF THE INVENTION

The object of the present application is to provide a control method for a tire building machine, a control system and a readable storage medium, so as to solve the problems of complicated mechanical structure of the whole machine, large occupied space and complex control and easy interference with each other.

In order to achieve the described object, the present application provides a control method for a tire building machine. The tire building machine comprises a first mechanical arm and a second mechanical arm which are arranged on a machine frame of the building machine, wherein the first mechanical arm comprises a first mechanical arm and a first mechanical arm arranged on a wrist part of the first mechanical arm, and a first press roller part and a first claw part are arranged on the first mechanical arm; the second mechanical arm comprises a second mechanical arm and a second mechanical arm provided at a wrist portion of the second mechanical arm, a second press roller portion and a second claw portion are provided on the second mechanical arm, and the control method comprises:
step S1: in response to a signal of installing a bead, the second mechanical arm body drives the second claw portion to move to a material preparation region of the tire molding machine, and the second claw portion performs a grasping action on the bead and the spacer; the second mechanical arm body drives the second claw portion to place the bead onto a preset position of the bead of the tire forming machine and place the spacer onto a spacer placement position of the tire forming machine;
step S2: in response to a green tire rolling signal, the first mechanical arm body drives the first pressing roller portion to roll a first sidewall of a green tire on a forming drum of the tire forming machine and a portion of the tread adjacent to the first sidewall, and at the same time, the second mechanical arm body drives the second pressing roller portion to roll a second sidewall of the green tire and a portion of the tread adjacent to the second sidewall;
Step S3: in response to a green tire unloading signal, the first mechanical arm body drives the first claw portion to grip a green tire, and transfers the green tire to a tire unloading position.

Preferably, in the step S1, the bead and the spacer are alternately stacked horizontally in the material preparation area, and when the second claw portion grips the bead and the spacer, two beads and two spacers are grabbed each time, or one bead and one spacer are grabbed each time;

Each time two beads and two spacers are gripped, the placement of the beads and spacers is carried out according to the following procedure:
step S11: the second mechanical arm body drives the second claw portion to place one spacer on the bottom layer to the spacer placement position;
step S12: the second mechanical arm body drives the second claw portion to place one of the beads located on the bottom layer on one of the mounting sides of the beads;
step S13: the second mechanical arm body drives the second claw portion to place another spacer on the bottom layer to the spacer placement position;
step S14: controlling the preset turning-over of the bead by 180 degrees;
step S15: the second mechanical arm body drives the second claw portion to place another bead on another mounting side of the bead seat;
when one bead and one spacer are grabbed at a time, placing the bead and the spacer according to the following method: sequentially executing steps S11 and S12; otherwise, S13, S14 and S15 are performed in sequence.

Preferably, in the step S2, when the green tire on the shaping drum is rolled, the first pressing roller portion and the second pressing roller portion are kept symmetrical with respect to the center face of the green tire.

Preferably, in the step S2, when the green tire is rolled on the shaping drum, the degree of symmetry of the first roller portion and the second roller portion is required to be ±0.5 mm.

Preferably, in the step S2, when the first robotic arm or the second robotic arm performs a green rolling operation, the first pressing roller portion and the second pressing roller portion rotate following a green tire rotation on the forming drum, and the first mechanical arm body drives the first press roller portion to move according to a first pre-set rolling curve, the second mechanical arm body drives the second press roller portion to move according to a second pre-set rolling curve;

wherein the first predetermined rolling curve is a predetermined curve corresponding to the first sidewall and a portion of the tread adjacent to the first sidewall; the second preset rolling curve is a preset curve corresponding to the second sidewall and a portion of the tread adjacent to the second sidewall.

Preferably, the material preparation zone is provided with a bead trolley, and the bead and the spacer are alternately stacked horizontally on the bead trolley, and the step S1 further comprises the following sub-steps:
step S101: monitoring in real time whether a bead on the bead trolley has been taken out, and if so, turning the idle bead trolley away and driving the bead trolley carrying the bead into the material preparation area; If not, continue monitoring.

Preferably, the spacer placement position is provided with a spacer placement carriage arranged next to the bead trolley, and the step S1 further comprises the following sub-steps:
Step S102: monitoring whether the spacer placing vehicle is fully loaded, and if yes, transferring the fully loaded spacer placing vehicle away and transporting the unloaded spacer placing vehicle to the spacer placing position; If not, continue monitoring.

Compared with the introduction of the background art, the described method for controlling a tire forming machine. The tire forming machine comprises a first mechanical arm and a second mechanical arm provided on a machine frame of the forming machine, wherein the first mechanical arm comprises a first mechanical arm and a first mechanical arm provided on a wrist part of the first mechanical arm, and a first press roller part and a first claw part are provided on the first mechanical arm; a second mechanical arm comprises a second mechanical arm body and a second mechanical arm provided at a wrist portion of the second mechanical arm body, a second press roller portion and a second claw portion are provided on the second mechanical arm body, and the control method comprises: in response to a signal for mounting a tire bead, the second mechanical arm body drives the second claw portion to move to a material preparation region of a tire forming machine, and the second claw portion performs a grasping action on the tire bead and a spacer; the second mechanical arm body drives the second claw portion to place the tire bead on the preset bead of the tire forming machine and place the spacer on the spacer placement position of the tire forming machine; in response to a green tire rolling signal, a first mechanical arm body drives a first pressing roller portion to roll a first sidewall of a green tire on a forming drum of a tire forming machine and partial tread adjacent to the first sidewall, and at the same time, a second mechanical arm body drives a second pressing roller portion to roll a second sidewall of the green tire and partial tread adjacent to the second sidewall; In response to the green tire unloading signal, the first mechanical arm body drives the first claw portion to grip the green tire, and transfers the green tire to the tire unloading position. During tire molding, the robotic arm is controlled by means of the described control method, so that integrated control of bead placement, side rolling of a green tire, and operation of removing the green tire can be realized. Compared with the conventional separate operation of different mechanical devices, the occupation space of the mechanical equipment is greatly reduced, At the same time, the complexity of the control is reduced, and the possibility of interference between the actuating mechanical parts is avoided.

In addition, the present application also provides a control system for a tire building machine, comprising a controller, wherein the controller can control actions of the first mechanical arm and the second mechanical arm according to the control method described in any one of the described solutions. Since the described control method has the described technical effect, the control system should also have the corresponding technical effect, and it will not be described again here.

In addition, the present application further provides a readable storage medium, on which a computer program is stored, and when the computer program is executed by a processor, the control method for a tire building machine described in any one of the described solutions can be implemented.

### BRIEF DESCRIPTION OF THE DRAWINGS

To describe the technical solutions in the embodiments of the present application or in the prior art more clearly, the following briefly introduces the accompanying drawings required for describing the embodiments or the prior art, Apparently, the accompanying drawings in the following description show merely some embodiments of the present application, other drawings may also be obtained according to these drawings without creative efforts.

FIG. 1 is a schematic diagram of an overall structure of a tire building machine provided by an embodiment of the present application;

FIG. 2 is a schematic structural diagram of a manipulator arm provided by an embodiment of the present disclosure;

FIG. 3 is a schematic flowchart of a control method of a tire building machine according to an embodiment of the present application.

The figures include the following reference signs:
1: a first mechanical arm; 11: a first mechanical arm body; 12: a first mechanical arm; 12a: a first press roller portion; 12b: a first claw portion; 2: a second mechanical arm; 21: a second mechanical arm body; 22: a second mechanical arm; 22a: a second press roller portion; 22b: a second claw portion; 3: a forming drum; 4: a tire unloading position; 5: a stock zone; 6: a bead pre-setting; 7: a spacer placement position.

### DETAILED DESCRIPTION OF THE EMBODIMENTS

The core of the present application is to provide a control method and control system for a tire building machine, and a readable storage medium, so as to solve the problems that the mechanical structure of the whole machine is complex, the occupied space is large, and the control is complex and the machine easily interferes with each other.

To make persons skilled in the art better understand the technical solutions provided in the present application, the present application is further described in detail in the following with reference to the accompanying drawings and specific embodiments. Apparently, the embodiments to be described are only a part rather than all of the embodiments of the present application. All other embodiments obtained by a person of ordinary skill in the art based on the embodiments of the present application without creative efforts shall belong to the scope of protection of the present application.

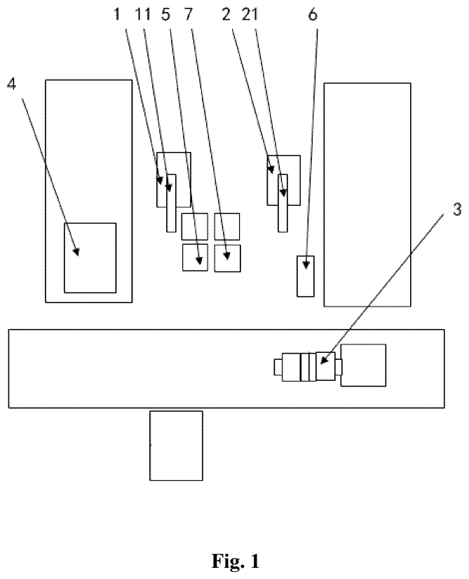

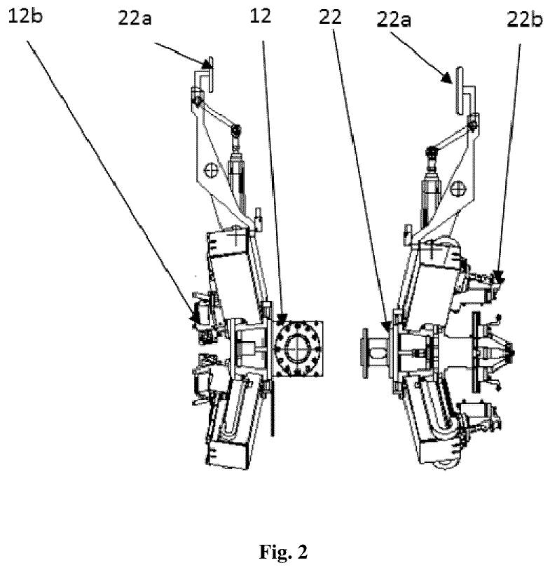

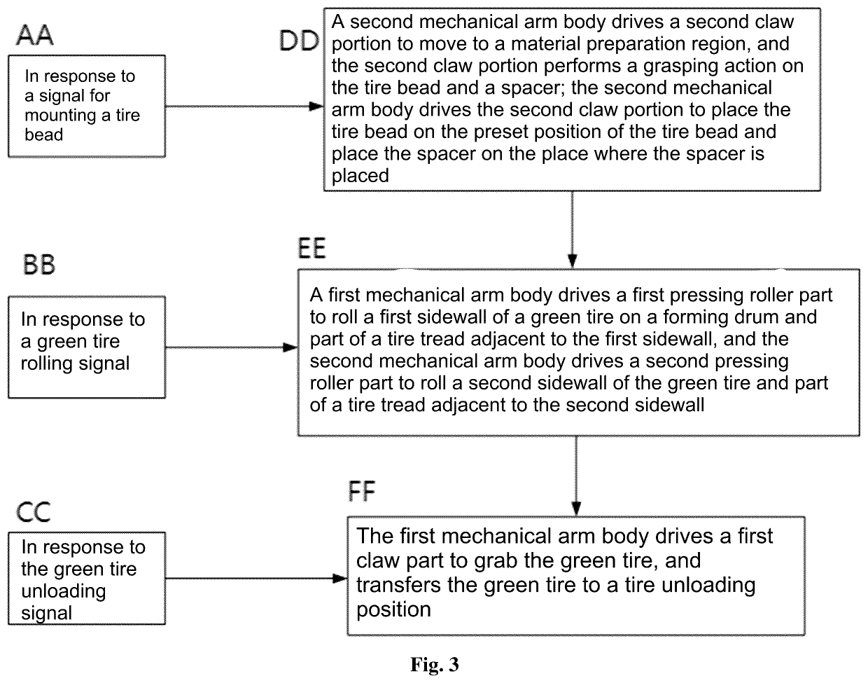

As shown in FIGS. 1-3, the embodiments of the present application provide a control method for a tire building machine. The tire building machine comprises a first robotic arm 1 and a second robotic arm 2 disposed on a frame of the building machine, The first mechanical arm 1 comprises a first mechanical arm 11 and a first mechanical arm 12 arranged at a wrist part of the first mechanical arm 11, a first press roller portion 12a and a first claw portion 12b are provided on the first mechanical hand 12; the second mechanical arm 2 comprises a second mechanical arm body 21 and a second mechanical arm 22 provided at a wrist part of the second mechanical arm body 21, and a second press roller 22a and a second claw part 22b are provided on the second mechanical arm 22. The control method comprises:

step S1: in response to a signal for mounting a tire bead, the second mechanical arm body 21 drives the second claw portion 22b to move to the material bearing region 5 of the tire building machine, and the second claw portion 22b performs a gripping action on the tire bead and the spacer; the second mechanical arm body 21 drives the second claw portion 22b to place the bead on the bead seat 6 of the tire forming machine and place the spacer on the spacer placement position 7 of the tire forming machine;
step S2: in response to a green tire rolling signal, the first mechanical arm body 11 drives the first roller portion 12a to roll a first sidewall of a green tire on a forming drum 3 of a tire forming machine and a portion of the tread adjacent to the first sidewall, and at the same time, the second mechanical arm body 21 drives the second roller portion 22a to roll a second sidewall of the green tire and a portion of the tread adjacent to the second sidewall;
Step S3: in response to a green tire unloading signal, the first mechanical arm body 11 drives the first claw portion 12b to grab a green tire, and transfers the green tire to the tire unloading position 4.

During tire molding, the robotic arm is controlled by means of the described control method, so that integrated control of bead placement, side rolling of a green tire, and operation of removing the green tire can be realized, Compared with the conventional separate operation of different mechanical devices, the occupation space of the mechanical equipment is greatly reduced, At the same time, the complexity of the control is reduced, and the possibility of interference between the actuating mechanical parts is avoided.

Here, it should be noted that the first mechanical arm body or the second mechanical arm body is generally formed by connecting multiple joints and is configured with corresponding actuators, so that the first mechanical arm body or the second mechanical arm body can drive respective mechanical arms to move in various directions in the space. Since the mechanical arm body part belongs to the prior art, no more detailed description is made herein.

It should also be noted that, in a practical application process, the first claw portion may also be used to grab the tire bead and the spacer, but in order to avoid a possibility of mutual interference between the first robotic arm and the second robotic arm, the first claw portion and the second claw portion work together, the first claw portion is used to grab the green tire, and the second claw portion is used to grab the tire bead and the spacer.

It should be noted that, persons skilled in the art should understand that, in order to prevent adhesion between two adjacent beads, generally, a spacer is required between the two adjacent beads to be separated from each other, so that the beads and the spacers are placed on the stock area 5 in an alternating horizontal stacking manner.

In some specific embodiments, in the above step S1, the beads and the spacers are alternately stacked horizontally in the stock area 5, and when the second claw part 22b grips the beads and the spacers, two beads and two spacers are grabbed each time, or one bead and one spacer are grabbed each time;

Each time two beads and two spacers are gripped, the placement of the beads and spacers is carried out according to the following procedure:
step S11: the second mechanical arm body 21 drives the second claw portion 22b to place one spacer on the bottom layer to a spacer placement position 7;
step S12: the second mechanical arm body 21 drives the second claw portion 22b to place a bead on the bottom layer on a mounting side of the bead seat 6;
step S13: the second mechanical arm body 21 drives the second claw portion 22b to place another spacer at the bottom layer to the spacer placement position 7;
step S14: controlling the bead predisposing 6 to flip 180 degrees;
Step S15: the second mechanical arm body 21 drives the second claw portion 22b to place the other bead onto the other mounting side of the bead seat 6.

By designing the bead seat in such a way that it can be turned over, when one is placed on the bead seat, Again, with the second bead placement, the second bead would only have to be placed by pre-flipping the bead over 180° C., greatly reducing the complexity of the second mechanical arm body for driving the movement control of the second claw portion, and using the operation of grabbing the two beads and the two spacers at one time, Thus, the capturing time is greatly saved, and the working efficiency is improved.

when one bead and one spacer are grabbed at a time, placing the bead and the spacer according to the following method: sequentially executing steps S11 and S12; otherwise, S13, S14 and S15 are performed in sequence.

In some specific embodiments, in the step S2, when the green tire is rolled on the building drum 3, the first pressing roller portion 12a and the second pressing roller portion 22a are kept symmetrical with respect to the center face of the green tire. By arranging the first pressing roller portion and the second pressing roller portion symmetrically relative to the central plane of the green tire, rolling of the green tire becomes more uniform and symmetrical. The degree of symmetry of the first pressure roller portion 12a and the second pressure roller portion 22a is generally required to be ±0.5 mm. By designing the degree of symmetry of the rolling of the first roller portion and the second roller portion to be within the tolerance, relevant requirements for manufacturing a green tire can basically be met. Definitely, it can be understood that, in an actual application process, other corresponding degree of symmetry values may also be selected according to actual requirements, which is not specifically limited herein.

In some more specific embodiments, in the step S2, when the first robotic arm or the second robotic arm performs a green rolling operation, the first pressing roller portion 12a and the second pressing roller portion 22a rotate following the rotation of the green tire on the forming drum 3, and the first mechanical arm body 11 drives the first pressing roller portion 12a to move according to a first pre-set rolling curve, the second mechanical arm body 21 drives the second press roller portion 22b to move according to a second pre-set rolling curve; wherein the first pre-set rolling curve is a pre-set curve corresponding to the first sidewall and a part of the tread adjacent to the first sidewall; the second preset rolling curve is a preset curve corresponding to the second sidewall and a part of the tread adjacent to the second sidewall. By means of designing the first roller portion or the second roller portion to perform rolling in a manner of rotating two times following the rotation of the green tire, compared with friction rolling, the rolling effect can be improved, and the surface smoothness of the sidewall can be improved. It should be noted that, in general, the first preset rolling curve and the second preset rolling curve are symmetric, and depending on the design sidewall curve of the green tire, the first robotic hand or the second robotic hand drives the first roller portion or the second roller portion to roll during the process of moving the forming drum, and generally, the following distance is about 800 mm (the actual dynamic following distance is determined according to the simulation effect and on-site debugging).

In a further embodiment, the described tire unloading position 4 may specifically be a green tire unloading conveying line, and after the green tire is completely unloaded, the green tire is directly conveyed to a subsequent process via the green tire unloading conveying line, so that the whole production process is more coherent. Of course, it can be understood that the tire unloading position can also be a tire detecting station, and then the detection can be performed at the same time when the tire unloading is completed.

In some more specific embodiments, the material preparation zone 5 may specifically be provided with a bead trolley, and the bead and the separation sheet are alternately stacked horizontally on the bead trolley, and the step S1 further comprises the following sub-steps:
step S101: monitoring in real time whether a tire bead on a tire bead trolley has been taken out, and if so, turning the tire bead trolley unloaded and driving the tire bead trolley loaded with the tire bead into a material bearing region 5; If not, continue monitoring. Thus, the automation degree of the tire bead filler is greatly improved, and it should be understood by those skilled in the art that, In order to prevent the adhesion between two adjacent beads, generally, the two adjacent beads need to be separated by a spacer, Therefore, the beads and the spacers are placed on the bead trolley in a manner of alternately stacking horizontally, wherein the bottommost spacer can be a structure formed on the bead trolley, It may also be a spacer placed on the bead trolley.

In a further embodiment, the described spacer placement position 7 may specifically be provided with a spacer placement carriage arranged adjacent to the bead trolley, and said step S1 further comprises the following sub-steps:
Step S102: monitoring whether a spacer placing trolley is fully loaded, and if so, transferring the fully loaded spacer placing trolley away and transporting the unloaded spacer placing trolley to a spacer placing position 7. If not, continue monitoring. By designing a partition placing trolley at a partition placing position, the automation degree of a tire forming machine can be greatly improved, and it is ensured that the tire forming machine keeps a partition placing position with a partition placing space without stopping; Furthermore, by arranging the spacer placement trolley closely adjacent to the bead trolley, the movement path of the second mechanical arm body can be reduced, and the spacer placement efficiency and convenience are improved.

In addition, the present application also provides a control system for a tire building machine, comprising a controller, wherein the controller can control actions of the first mechanical arm and the second mechanical arm according to the control method described in any one of the described solutions. Since the described control method has the described technical effect, the control system should also have the corresponding technical effect, and it will not be described again here.

In addition, the present application further provides a readable storage medium, on which a computer program is stored, and when the computer program is executed by a processor, the control method for a tire building machine described in any one of the described solutions can be implemented.

For better understanding of the technical solution of the present application by a person skilled in the art, a brief description will be given below with reference to a specific working process of a tire building machine:
a first mechanical arm or a second mechanical arm respectively drives a pressure roller part on each mechanical arm to simultaneously reach a rolling starting position to carry out green tire rolling, and the mechanical arm performs rolling in the process of following a forming drum to follow a distance of about 800 mm (an actual dynamic following distance is determined according to a simulation effect and on-site debugging). During the rolling process, the rolling portion needs to perform rolling according to a set rolling path curve, and during the rolling process, the required degree of symmetry of the rolling portion relative to the central plane of the tire is +0.5 mm.
the first robotic arm withdrawing from the adjustment posture, grabbing a green tire by means of the first claw portion, and placing the taken green tire on a green tire discharging and conveying line, in which a placing surface of the green tire is generally 3.2 m away from the ground, and the first robotic arm waits for a green tire rolling pressure signal;

While the first robotic arm is working, the second robotic arm moves to the material preparation area to perform a bead fetching operation, and horizontally fetches the bead and the spacer (the bead and the spacer are generally alternately stacked horizontally in the bead car). Generally, the material preparation area is on the left side, the beads and the spacers are placed on the tire bead trolley in the material preparation area (the number of the spacers here is determined according to actual situations), and the empty vehicle or a certain number of the spacers are placed on the right side, which can also be changed according to actual needs. at this moment, the second claw portion of the second robotic arm needs to grab two beads and two spacers, and the second robotic arm moves to a spacer placement position, placing one spacer horizontally, clamping a bead to move to a preset bead, and placing one bead on the preset bead, the second mechanical hand moves again to the spacer placement position, one spacer is placed horizontally again, and the bead is preset to rotate 180 degrees, the second robotic arm clamps the second bead to move to the preset bead, and places the bead on the preset bead, completing the circling action and giving a completion signal;
the first robotic arm or the second robotic arm waiting for the forming machine to complete working, and receiving a green tire rolling pressure signal;
after receiving a green tire rolling signal, a first robotic arm or a second robotic arm simultaneously starting a rolling operation of a tire side of a green tire at a rolling position, and for the specific requirements, reference can be made to the description of the described rolling operation;

The above operation is circulated.

It should be noted that, in order to facilitate the test of the green tire, after the first robotic hand has completed the removal of the tire, the tire can be selectively sent to the front side of the main line, the distance is transferred to 500 mm or more, and the tire is placed on the tire testing roller for testing.

The control method, the control system and the readable storage medium of the tire building machine according to the present invention have been described above in detail. It should be noted that, each embodiment in this description is described in a progressive manner, each embodiment focuses on a difference from other embodiments, and reference may be made to the same or similar parts among the embodiments.

It should also be noted that, in this specification, terms such as ‘include’, ‘comprise’, or any other variation thereof are intended to cover a non-exclusive inclusion, so that an item or a device that includes a series of elements not only includes those elements, but also includes other elements that are not explicitly listed, or further includes elements that are inherent to the item or the device. If no more limitations are imposed, an element limited by ‘include a . . . ’ does not exclude that another same element exists in an article or a device that includes the foregoing element.

The principle and embodiments of the present disclosure are described herein through specific examples, and the description of the above embodiments is only used to help understand the core idea of the present disclosure. It should be noted that, a person of ordinary skill in the art may further make improvements and modifications to the present application without departing from the principle of the present application, and these improvements and modifications also belong to the scope of protection of the claims of the present application.

1. A control method for a tire building machine, the tire building machine comprises a first mechanical arm (1) and a second mechanical arm (2) provided on a machine frame of the building machine, wherein a first pressing roller portion (12a) and a first claw portion (12b) are provided on the first mechanical arm (1); a second press roller part (22a) and a second claw part (22b) are provided on the second mechanical arm (2), characterized in that the control method comprises:
step S1: in response to a signal of installing a bead, the second claw portion (22b) gripping the bead and the spacer and placing the bead onto a bead seat (6) of the tire building machine and placing the spacer onto a spacer placement position (7) of the tire building machine;
step S2: in response to a green tire rolling signal, the first pressing roller portion (12a) rolling a first sidewall of a green tire on a forming drum (3) of the tire building machine and a portion of the tread adjacent to the first sidewall, while the second pressing roller portion (22a) rolling a second sidewall of the green tire and a portion of the tread adjacent to the second sidewall;
step S3: in response to a green tire unloading signal, the first claw portion (12b) grabs a green tire and transfers the green tire to a tire unloading position (4).

2. The control method for a tire building machine according to claim 1, wherein in step S1, the bead and the spacer are alternately stacked horizontally in a material preparation area (5), and when the second claw part (22b) grips the bead and the spacer, two beads and two spacers are gripped each time, or one bead and one spacer are gripped each time;
each time two beads and two spacers are gripped, the placement of the beads and spacers is carried out according to the following procedure:
step S11: the second claw portion (22b) places one spacer on the bottom layer to the spacer placement position (7);
step S12: said second claw portion (22b) places a bead, located at the bottom level, on a mounting side of the bead seat (6);
step S13: the second claw portion (22b) places another spacer on the bottom layer to the spacer placement position (7);
step S14: controlling the bead pre-setting (6) to flip 180 degrees;
step S15: the second claw portion (22b) places another bead on the other mounting side of the bead seat (6);
when one bead and one spacer are grabbed at a time, placing the bead and the spacer according to the following method: sequentially executing steps S11 and S12; otherwise, S13, S14 and S15 are performed in sequence.

3. The control method for a tire building machine according to claim 1, wherein in the step S2, when a green tire on the building drum (3) is rolled, the first roller portion (12a) and the second roller portion (22a) are kept symmetrically with respect to a center plane of the green tire.

4. The control method for a tire building machine according to claim 3, wherein in the step S2, when a green tire on the building drum (3) is rolled, the degree of symmetry of the first roller portion (12a) and the second roller portion (22a) is required to be ±0.5 mm.

5. The control method for a tire building machine according to claim 3, wherein in step S2, when a first robotic arm or a second robotic arm executes a green tire rolling operation, the first pressing roller part (12a) and the second pressing roller part (22a) rotate following the green tire rotation on the shaping drum (3), the first pressing roller part (12a) moves according to a first pre-set rolling curve, and the second pressing roller part (22a) moves according to a second pre-set rolling curve;
wherein the first predetermined rolling curve is a predetermined curve corresponding to the first sidewall and a portion of the tread adjacent to the first sidewall; the second preset rolling curve is a preset curve corresponding to the second sidewall and a portion of the tread adjacent to the second sidewall.

6. The control method for a tire building machine as claimed in claim 2, characterized in that said material preparation zone (5) is provided with a tire bead trolley, and said beads and spacers are alternately stacked horizontally on said tire bead trolley, and said step S1 further comprises the following sub-steps:
step S101: monitoring in real time whether a bead on the bead trolley has been taken out, and if so, then rotating the idle bead trolley away and driving the bead trolley carrying the bead into the material-bearing region (5); If not, continue monitoring.

7. The control method for a tire building machine according to claim 6, wherein the spacer placement position (7) is provided with a spacer placement carriage arranged next to the bead trolley, and the step S1 further comprises the following sub-steps:
step S102: monitoring whether the spacer placing trolley is fully loaded, and if yes, transferring the fully loaded spacer placing trolley away and transporting the unloaded spacer placing trolley to the spacer placing position (7); If not, continue monitoring.

8. The control method for the tire building machine according to claim 1, the second mechanical arm (2) comprises a second mechanical arm body (21) and a second mechanical arm (22) arranged at a wrist part of the second mechanical arm body (21), the second pressing roller part (22a) and the second claw part (22b) are arranged on the second mechanical arm (22), wherein in step S1, the second mechanical arm (2) drives the second claw part (22b) to move;
the first mechanical arm (1) comprises a first mechanical arm (11) and a first mechanical arm (12) arranged at a wrist part of the first mechanical arm (11), the first press roller portion (12a) and the first claw portion (12b) are provided on the first mechanical hand (12), wherein, in the step S2, the first mechanical arm (1) is used for the first press roller portion (12a) to move so that the first press roller portion (12a) rolls the first sidewall of the green tire and a portion of the tread adjacent to the first sidewall, the second robotic arm (2) drives the second press roller part (22a) to move so that the second press roller part (22a) rolls the second sidewall of the green tire and a portion of the tread adjacent to the second sidewall;
the first mechanical arm body (11) drives the first claw portion (12b) to grab the green tire, and transfers the green tire to the tire unloading position (4).

9. A control system for a tire building machine, comprising a controller, characterized in that the controller can control actions of the first mechanical arm (1) and the second mechanical arm (2) according to the control method as claimed in claim 1.

10. A readable storage medium storing a computer program thereon, wherein when the computer program is executed by a processor, the control method for a tire building machine according to claim 1 is implemented.
